(19) United States
(12) Patent Application Publication
(10) Pub. No.: US 2004/0026672 A1
(43) Pub. Date: Feb. 12, 2004

(54) Alternative jack attachment point

(76) Inventor: Peter Caloger, Gunnison, CO (US)

Correspondence Address: Gary M. Anderson, Suite 1550, 200 Oceangate, Long Beach, CA, 90802, US

(21) Appl. No.: 10/217,203

(22) Filed: Aug. 12, 2002

(51) Int. Cl. B66F 1/00

(52) U.S. Cl. 254/1

(57) ABSTRACT

An apparatus to be used in conjunction with a jack for raising a vehicle by one of its wheel hubs when the vehicle has become stuck in a rut or when the vehicle's jacking points are inaccessible. The substantially hollow apparatus is strengthened for use with heavy vehicles with a reinforcing bar. The apparatus is secured to a vehicle's wheel hub through interaction between the connection members incorporated in the apparatus and lug nuts or bolts of the vehicle. The horizontal component of the jack is inserted into the hollow cross-section of the apparatus and then raised. The result of which is that the vehicle is raised to a point where the vehicle's wheel is raised out of the rut or to the height where the jacking points are accessible.

### BACKGROUND OF THE INVENTION

1. Field of the Invention

The present invention relates to improvements in vehicular lifting devices, and more particularly to a device used in conjunction with a vehicular jack so as to raise a vehicle that has become stuck in a rut and/or whose jacking points have become inaccessible.

2. Description of the Prior Art

Generally, conventional jacks are used to lift vehicles in order to perform maintenance or make repair. When performing such maintenance or repair, conventional jacks are usually first placed under the frame or body of the vehicle.

Under normal circumstances, access to the underside of a vehicle or jack attachment point is readily available. But when one or more wheels of a vehicle sinks in a rut, mud or soft sand, or when the suspension of a vehicle is lowered below the factory ride height, access to the underside of the car becomes very difficult and sometimes impossible. In the case of a vehicle stuck in a rut, a tow truck is usually required to remove the vehicle from the compromising position. The removal is costly and in some situations the removal process will damage the vehicle.

Most tow trucks do not have the off-road capabilities to reach a vehicle which has become stuck in off-road areas. In such situations where access to a tow vehicle is not available, it may be necessary for the vehicle's owner to dig the wheel out him or herself. The digging out process may take several hours depending upon the depth to which the wheel of the vehicle has sunk and the type of soil the vehicle has sunken in.

Similarly, when a vehicle is lowered below the factory ride-height settings, placement of a conventional jack underneath the car becomes quite difficult. In many instances the stand or jack will not attach at the designed jack attachment point resulting in the placement of the jack at locations not designed for such purposes.

There have been numerous attempts in the prior art to solve the problem of raising a vehicle stuck in a rut or with non-accessible jacking points. Most of the apparatuses propose a solution whereby an attachment is connected to the hub of a vehicle. These apparatuses usually have a jack receiving component extending horizontally which enables the apparatuses to receive a conventional jack head. The problem with these apparatuses is that they may allow the vehicle to fall off of the mount. Because the apparatuses lack a manner of positively coupling the jack and the vehicle, a shock to the vehicle can cause the vehicle to fall off of the jack.

Vehicles are susceptible to falling off jacks under a variety of circumstances. The most common scenario takes place when force is exerted to the raised vehicle. In this case an individual is usually trying to loosen or tighten a nut or bolt on the vehicle. The individual applies the force to the related part of the vehicle, and the force overcomes the frictional resistance between the jack and the prior art apparatus. The result is usually that the vehicle will fall off the jack and on to the ground. When this event happens the individual working on the car is likely to be severely injured.

An improved device to be used in conjunction with a jack for raising a vehicle is therefore needed. More particularly, such an apparatus must provide access to a point on the vehicle for jacking when the vehicle has sunk into the ground or when the jack points are not accessible. The device must also provide a higher degree of safety than conventional jack attachments and must be relatively inexpensive to manufacture.

### SUMMARY OF THE INVENTION

Briefly, and in general terms, the present invention provides a new and improved apparatus for lifting vehicles. More specifically, the apparatus and accompanying method provide a jacking mount which is used in conjunction with a vehicular jack so as to raise a vehicle that has become stuck in a rut and/or whose jacking points have become inaccessible.

The jacking mount can be generally cylindrical in configuration, having a hollow center section. This construction enables the mount to be attached to studs or bolts protruding from a vehicle's hub. With the mount in place, a horizontally extending lifting component of a jack is inserted into the hollow center of the device. The jack is then raised so as to raise the vehicle. In doing so, the horizontal component of the jack applies force to the inner surface of the mount in the vertical direction. The mount, which is secured to the vehicle through the vehicle's hub, is then raised. After the vehicle is raised, a board can be placed under the raised wheel or another jack can be placed underneath the vehicle in a standard jacking location.

In one embodiment the vehicular jacking mount takes the form of an elongate, substantially cylindrical body comprising a distal and proximal end, a hollow cross-section for accepting the horizontal component of a conventional vehicular jack in the proximal end, an inner and outer surface, an elongate reinforcing bar coupled to the mount's inner cylindrical surface, and a plurality of connection members with openings therein coupled to the distal end of the body in a substantially perpendicular and radially outward manner so as to be capable of coupling the cylindrical body to a wheel of a vehicle through the wheel studs or bolts of the vehicle.

A plurality of elongate reinforcing bars instead of merely one such bar can be coupled with the cylindrical body in a similar fashion so as to further increase the body's strength. Further, the elongate reinforcing bar or bars can also be coupled to the cylindrical body along the outer surface of the cylindrical body to increase the cylindrical body's strength. In all of the embodiments, the elongate reinforcing bar can be coupled to the cylindrical body with a weld connection or by other conventional means. Both the cylindrical body and the elongate reinforcing bar can be manufactured from steel, aluminum alloy, or any other material suitable for lifting a vehicle.

The plurality of connection members coupled to the cylindrical body can be configured in a variety of ways. In one embodiment, the plurality of connection members includes only two connection members, which are separated by an angle of 180 degrees so that the openings in the connection members are alignable with the upper-most and bottom-most studs or bolts of the vehicle's hub. In another embodiment, the plurality of connection members are configured so that the openings within the connection members are specifically alignable with the studs or bolts of a 4, 5, 6, 7, or 8-lug vehicle wheel. To accommodate different types of wheels with varying spacing between the studs or bolts, the openings in the connection members can be slotted.

In another embodiment, the vehicular jacking mount comprises an elongate, substantially square body comprising a distal and proximal end a hollow cross-section for accepting the horizontal component of a conventional vehicular jack in the proximal end, an inner and outer surface, an elongate reinforcing bar coupled to the outer surface of the mount, and a plurality of connection members with openings therein coupled in a substantially perpendicular and radially outward manner to the distal end of the body so as to be capable of coupling the rectangular body to a wheel of a vehicle through the studs or bolts of the hub.

A plurality of elongate reinforcing bars can be coupled with the rectangular body in a similar fashion so as to further increase the rectangular body's strength. Further, the elongate reinforcing bar or bars can also be coupled to the rectangular body along the inner surface of the rectangular body to increase the rectangular body's strength. In all of the embodiments, the elongate reinforcing bar can be coupled to the rectangular body with a weld connection or by other conventional means. Both the rectangular body and the elongate reinforcing bar can be comprised of steel, aluminum alloy, or any other suitable material.

The plurality of connection members which are coupled to the rectangular body can be configured in a variety of ways. In one embodiment, the plurality of connection members includes only two connection members. In this embodiment, the connection members are separated by an angle of 180 degrees so that the openings in the connection members are alignable with the upper most and bottom most studs or bolts when the rectangular body is connected to the wheel. In another embodiment, a plurality of connection members are configured so that the openings within the connection members are slotted and are alignable with the studs or bolts of a 4, 5, 6, 7, or 8-lug hub.

In another embodiment the vehicular jacking mount comprises an elongate, cylindrical body comprising a distal and proximal end, a hollow cross-section for accepting the horizontal component of a jack in the proximal end, an inner and outer surface, a collar coupled to the cylinder, a plurality of connection members with openings therein positioned between the collar and the cylinder in a freely circumferentially rotating and substantially perpendicular and radially outward manner, an elongate reinforcing bar coupled with the cylindrical body between the distal end and the proximal end and along the inner surface of the cylindrical body so as to increase the cylindrical body's strength.

In an accompanying method for lifting a vehicle, the mount is first attached to the wheel of a vehicle. The horizontal lifting component of the jack is then aligned and inserted into the hollow cross-section of the mount. The jack is manipulated so as to raise the vehicle by means of the interaction between the lifting component of the jack and the inner surface of the device, attached to the hub of the vehicle. The vehicle is then lifted to a desired height and either a board or similar platform is placed under the previously stuck wheel or a conventional jack is placed under the vehicle.

These and other features and advantages of the present invention will become apparent from the following detailed description, taken in conjunction with the accompanying drawings, which illustrate, by way of example, the features of the invention.

### BRIEF DESCRIPTION OF THE DRAWINGS

FIG. 1 illustrates the various components of a preferred embodiment of the invention;

FIG. 2 is an end view of FIG. 1;

FIG. 2A illustrates an alternate preferred embodiment of the subject invention;

FIG. 2B illustrates another alternate preferred embodiment of the subject invention;

FIG. 3 is a cross sectional view, taken along lines 3-3 of FIG. 2;

FIG. 4 illustrates a preferred embodiment of the invention in use with a vehicular wheel and a jack;

FIG. 5 illustrates the various components of a preferred embodiment of the invention incorporating a support bar;

FIG. 6 is an end view of FIG. 5;

FIG. 7 illustrates the various components of a preferred embodiment of the invention incorporating a square cross-section and support bars;

FIG. 8 is an end view of FIG. 7;

FIG. 9 illustrates the various components of a preferred embodiment of the invention incorporating a collar and a support bar;

FIG. 10 is an end view of FIG. 9; and

FIG. 11 is an enlarged cross sectional view, taken along lines 11-11 of FIG. 10.

FIG. 12 is a cross-sectional view of an alternate preferred embodiment of the subject invention.

### DETAILED DESCRIPTION

Briefly, and in general terms, the present invention provides a new and improved apparatus for lifting vehicles. More specifically, the apparatus and accompanying method provide a device to be used in conjunction with a jack for raising a vehicle by one of its wheel hubs in a safe and convenient manner.

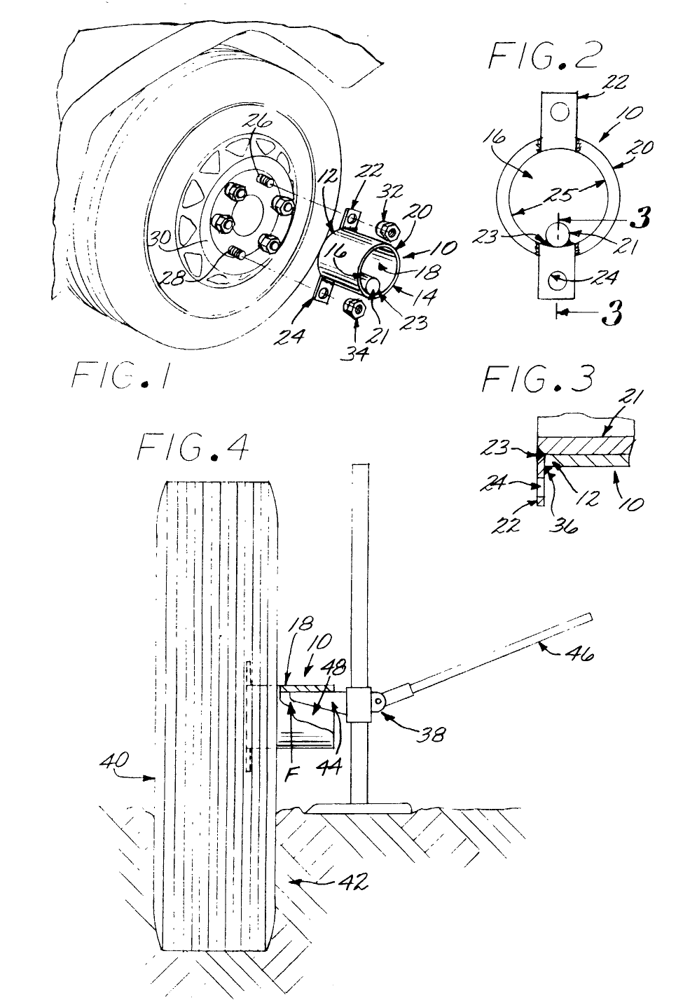

FIG. 1 illustrates a perspective view of a vehicular jacking mount 10 for use in connection with a vehicular jack and constructed in accordance with the present invention. The mount 10 is substantially cylindrical, comprising a distal end 12, proximal end 14, a substantially hollow cross-section 16, an inner surface 18 and outer surface 20. The mount 10 is formed with a body long enough to extend outward from the wheel hub and still accept the horizontal lifting component of a conventional jack while the body is attached to a vehicle. Cylindrical reinforcing bar 21 is coupled to the inner surface of the mount through a weld connection 23 which extends the length of the cylinder and increases the mount's resistance to bending. Connection members 22 with wheel stud openings 24 therein are welded to the distal end of the body in a substantially perpendicular and radially outward manner so as to be capable of coupling the mount to the vehicle through the wheel studs 26 and 28.

The connection members are alignable with the uppermost 26 and lower most 28 wheel studs of the vehicle's wheel hub. In this embodiment, the mount is configured to work with a vehicle wheel hub utilizing a symmetrical orientation of studs. To attach the jack mount 10, lug nuts 32 and 34 are removed from their respective wheel studs 26 and 28. The jack mount is then placed against the outside of the wheel 30, wherein the studs 26 and 28 penetrate the openings 24 of the connection members. The mount is secured to the vehicle by threading and tightening the upper most 32 and lower most 34 lug nuts over the connection members 22 and onto the studs 26 and 28.

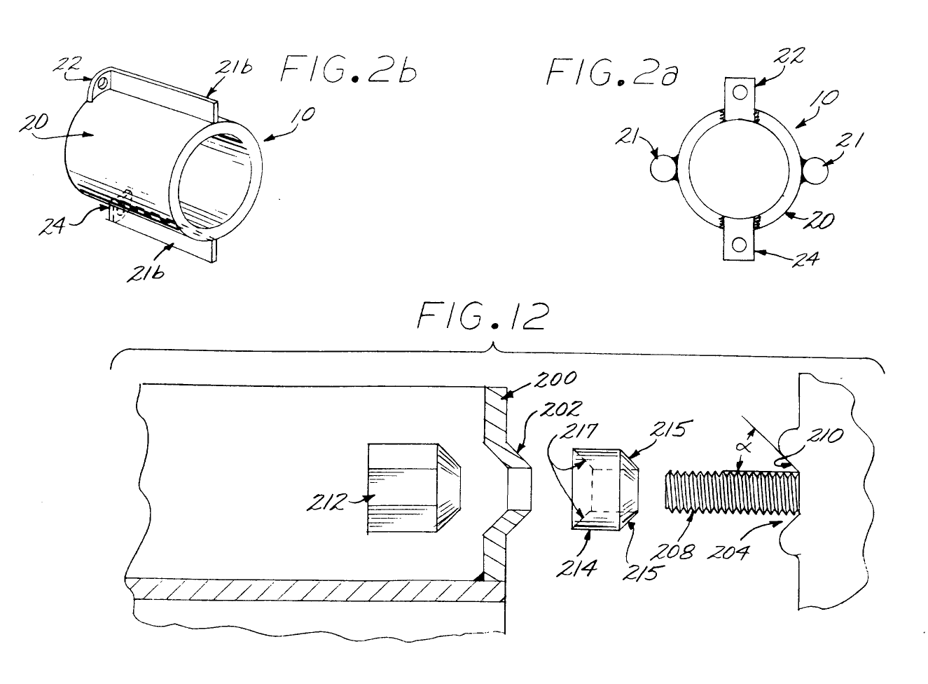

FIG. 2 illustrates an end view of the jack mount 10 described in FIG. 1, as viewed from distal end 12. Cylindrical reinforcing bar 21 is coupled to the inner surface of the mount through weld connection 23. Connection members 22 are mounted perpendicular to the tangent of the mount's cylindrical outer surface 20. Additionally, the connection members are mounted opposite from each other separated by an angle of approximately 180 degrees. The wheel stud openings 24 in the connection members are also located approximately 180 degrees apart from each other.

In many vehicles, a protruding housing or hub extends outward from the center of the vehicle's wheel. Typically, a protruding hub is present on vehicles equipped with four wheel drive. On some vehicles, the hub is in the form of a cap that is used to cover an axle nut. On four wheel drive vehicles, the protruding housing is frequently a housing for a wheel locking knob. In either case, the diameter 25 of the hollow cross-section 16 of the mount 10 must be greater than the largest diameter of the hub so as to ensure that the mount 10 fits securely onto the vehicle's wheel without unwanted interference. Further, the reinforcing bar 21 must not interfere with the hub so as to prevent a solid fitment of the mount 10. Therefore, as shown in FIG. 2A, on embodiments of the subject invention intended for use on four wheel drive vehicles or others with protruding wheel housings or hubs reinforcing bar 21 is positioned on the exterior surface of the mount's cylindrical outer surface 20.

Alternatively, as shown in FIG. 2B, the reinforcing member 21b may be integrally formed with or otherwise joined to the connection members. As shown in the embodiment in FIG. 2B, reinforcing member 21b forms a flange extending outward from the surface of the mount. Member 21b may be welded or otherwise joined with connection members 22 or it may be formed from an integral piece of metal formed into an L configuration as shown.

A cross-sectional view of the jack mount 10 taken along line 3-3 of FIG. 2 is shown in FIG. 3. Connection member 22 is positioned on the mount so as to be flush with the distal end 12 of the mount. The connection member 22 is coupled to the mount through a weld connection 36 which is suitable for stability purposes, but not to large as to interfere with opening 24 for the wheel stud. Cylindrical reinforcing bar 21 is also coupled to the inner surface of the mount through a weld connection 23 that spans the entire length of the bar 21.

FIG. 4 illustrates jacking mount 10 used in conjunction with jack 38. In this exemplary illustration, wheel 40 is shown embedded in a rut 42. When a vehicle is stuck in a rut or other depression or soft soil, as illustrated in FIG. 4, the normal jack attachment point for the vehicle is lowered to such a position that it cannot be safely accessed by the vehicle jack. In such situations, in order to raise the wheel from the rut jack mount 10 is connected to the vehicle wheel, lifting component 44 is first inserted into the mount. Generally, the jack handle 46 is then motioned in a positive and negative vertical direction to raise the jack. The horizontal lifting component 48 exerts a force on the inner surface 18 of the mount to raise the wheel from the rut.

FIG. 5 illustrates a perspective view of a vehicular jacking mount 50 for use in connection with a vehicular jack and constructed in accordance with the present invention. The mount is substantially cylindrical and comprises a distal end 52, proximal end 54, a substantially hollow cross-section 56, an inner surface 58 and outer surface 60. Three connection members 62 with wheel stud openings 64 therein are coupled, preferably by welding, to the distal end 52 of the body in a substantially perpendicular and radially outward manner. The jack mount 50 is formed with a body long enough to accept the horizontal lifting component of a conventional jack while the body is attached to a vehicle. Support structure 65 is coupled to the mount in order to strengthen the mount and prevent it from bending when the vehicle is raised. Support structure 65 is coupled to the mount through a weld connection 67 which extends the length of the structure 65. As shown in FIGS. 5 and 6, in this embodiment support structure 65 is a hollow, rectangular shaped to be extending the length of jack mount 50.

The three connection members 62 are alignable with the top 66, left 68 and right lower 70 studs of the vehicle. When the mount is placed against the outer surface of the wheel 72, the studs penetrate the openings 64 of the connection members 62. The mount is secured on the wheel hub by threading and tightening upper most 74 and left 76 and right (not shown) lower most lug nuts over the connection members 62 and onto the studs 66, 68 and 70.

A distal end view of the jacking mount 50 described in FIG. 5 is shown in FIG. 6. Connection members 80 are mounted perpendicular to the tangent of the cylindrical outer surface 60 of the mount. The connection members are mounted equidistant from each other about the periphery of distal end 52 of jack mount 56, and secured to the mount through weld connections 82. Support structure 65 is coupled to the mount on the lowermost outer surface to strengthen the mount and prevent the mount from bending when the vehicle is raised. The support structure is coupled to the mount through weld connection 67. Although shown as a rectangular box, it will be understood by those skilled in the art that support structure 65 can be of other configurations, such as a cylindrical rod or flange as discussed in the connection with the embodiment shown in FIGS. 2a and 2B.

As discussed above, a protrusion or hub extends outward from the center of many vehicle's wheel. On some vehicles, the protrusion is in the form of a cap which is used to cover an axle nut. On four wheel drive vehicles, the protrusion is frequently a housing for a wheel locking knob. In either case, the diameter 69 of the hollow cross-section 56 of the jack mount 50 must be greater than the largest diameter of the protrusion so as to ensure that the mount 50 fits securely onto the vehicle's wheel without unwanted interference with the protrusion.

FIG. 7 illustrates a perspective view of a vehicular jacking mount 84 for use in connection with a vehicular jack and constructed in accordance with another preferred embodiment of the present invention. The mount 84 includes a distal end 86, proximal end 88, a substantially hollow rectangular cross-section 90, an inner surface 92 and outer surface 94. Two connection members 96 with slotted openings 98 are coupled to the distal end of the jack mount 84 in a substantially perpendicular and radially outward manner. The jack mount 84 is formed with a body long enough to clear the wheel hub and accept the horizontal lifting component of a conventional jack while the body is attached to a vehicle. Support structures 100 are coupled to the mount through weld connections which extend the length of the bars in order to strengthen the mount and prevent it from bending when the vehicle is raised.

The connection members 96 are alignable with the top 102 and bottom 104 wheel studs of the vehicle. When the mount 84 is placed on the wheel hub, the wheel studs penetrate the openings of the connection members. The mount is secured on the wheel hub by threading and tightening the top 108 and bottom 110 lug nuts over the connection members 96 and onto the studs 102 and 104.

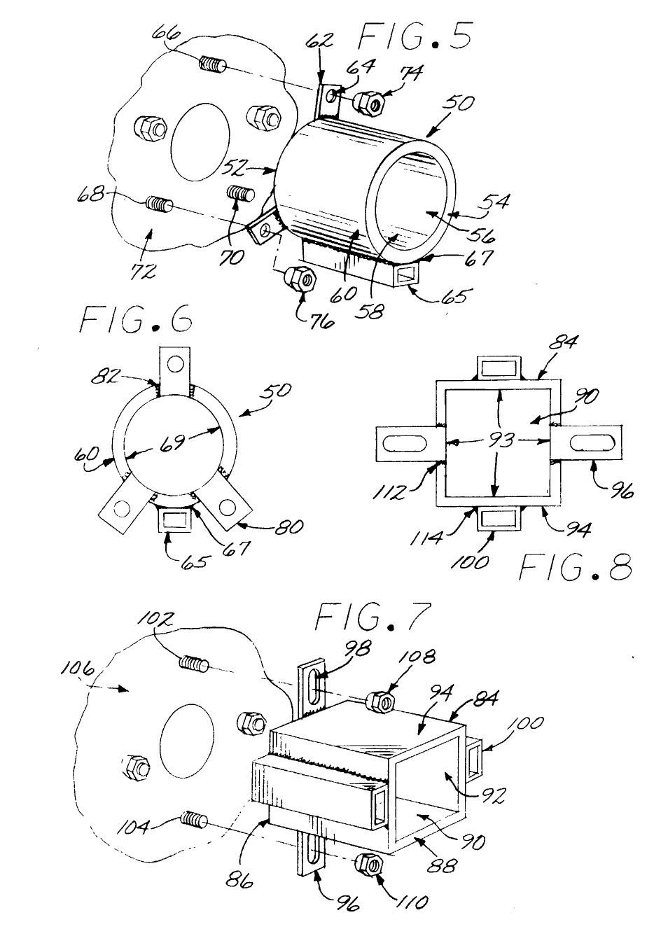

FIG. 8 shows a distal end view of the jacking mount 84 described in FIG. 7. Connection members 96 are mounted perpendicular to the square outer surface 94 of the mount. The connection members are mounted opposite from each other separated by an angle of 180 degrees and secured to the mount through weld connections 112. The connection members are slotted so as to be compatible with a wide range of vehicles. Where such vehicles have a small lug nut or bolt spacing, the inner most portion of the slots will be used. Where the vehicles have a large lug nut or bolt spacing, the outer most portion of the slots will be used. Support bars 100 are coupled to the mount 84 on the left and right outer surfaces so as to strengthen the mount and prevent it from bending when the vehicle is raised. The support structures are coupled to the mount through weld connections 114.

As discussed above, frequently a protrusion or hub in the form of a cap extends from the center of a vehicle's wheel. In this case, the height 93 and width 95 of the hollow cross-section 90 of the jack mount 84 must each be greater than the largest diameter of the protrusion so as to ensure that the jack mount 84 fits securely onto the vehicle's wheel without unwanted interference from the protrusion.

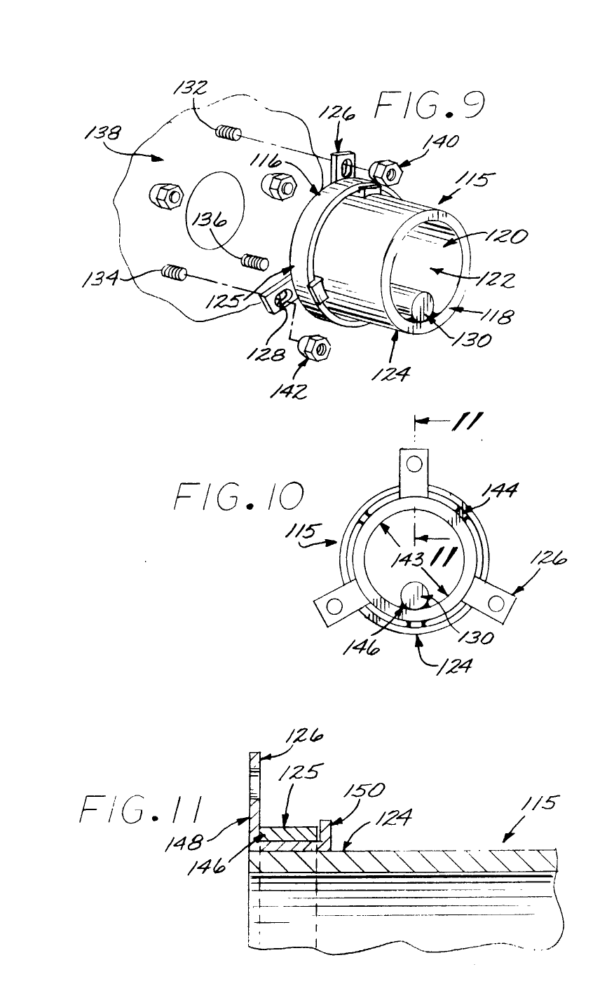

Referring now to FIG. 9, a perspective view of a vehicular jacking mount 115 for use in connection with a vehicular jack constructed in accordance with another preferred embodiment of the present invention is shown. The mount 115 is substantially cylindrical and comprises a distal end 116, proximal end 118, a substantially hollow cross-section 120, an inner surface 122, an outer surface 124 and a collar 125. Three connection members 126 with openings 128 therein are coupled between the outer surface of the mount and the inner surface of the collar 125 in a substantially perpendicular and radially outward manner. The mount 115 is formed with a body long enough to extend past the wheel hub and accept the horizontal lifting component of a conventional jack while the body is attached to a vehicle. Support structure 130 is coupled to the mount in order to strengthen the mount and prevent the mount from bending when the vehicle is raised. Support structure 130 is coupled to the mount through a weld connection extending the length of the bar 130. In this embodiment support structure 130 is a solid, cylindrical rod.

The connection members are alignable with the top 132, left 134 and right lower 136 wheel studs of the vehicle. When the mount is placed on the outside of the wheel, the studs extend through the openings 128 of the connection members 126. The mount is secured on the wheel hub by threading and tightening the upper most 140 and left 142 and right (not shown) lower most lug nuts over the connection members and onto the studs.

The collar 116 is attached to the mount through three weld connections 144 (shown in FIG. 10). The difference between the inner diameter of the collar 116 and the outer diameter of the cylinder is such that there is a sufficient space between the two to allow the connection members to freely circumferentially slide or rotate about the periphery of the jack mount.

The connection members 126 are slotted so as to be compatible with the wheel stud patterns on a wide range of vehicles. Where such vehicles have a small wheel stud or bolt spacing, the inner most portion of the slots will be used. Where the vehicles have a large wheel stud or bolt spacing, the outer most portion of the slots will be used. The combination of the free rotation of the connection members along with the slotted design enables the device to be adaptable to a wide variety of vehicle wheels.

A distal end view of the jacking mount 115 described in FIG. 9 is shown in FIG. 10. Connection members 126 are mounted perpendicular to the tangent of the cylindrical outer surface 124 of the mount. The connection members 126 are mounted opposite from each other separated by an angle of less than 180 degrees and secured to the jack mount 115 by collar 116 which in turn is secured to the jack mount 115 by means of three weld connections 144. Support bar 130 is coupled to the mount on the lowermost outer surface to strengthen the mount and prevent the mount from bending when the vehicle is raised. The support structure is coupled to the mount through weld connections 146.

In order to accommodate a protrusion or hub extending from the wheel, the diameter 143 of the hollow cross-section 120 of the mount 115 must be greater than the largest diameter of the protrusion so as to ensure that the mount 115 fits securely onto the vehicle's wheel without unwanted interference with the protrusion. Further, the reinforcing bar 130 must not interfere with the protrusion so as to prevent a solid fitment of the mount 115. In a variation of the embodiment shown in FIGS. 9 and 10, reinforcing bar 130 is coupled to the exterior surface 124 of the mount.

FIG. 11 illustrates a cross-sectional side view of the jack mount 115 taken along line 11-11 of FIG. 10. Connection member 126 is positioned on the mount so as to be free to rotate circumferentially between the cylindrical outer surface 124 of the mount and inner surface 146 of the collar 125. The connection member 126 is held in place under the collar through the interaction between the arm 148 of the connection member and the fastener 150 of the connection member with the collar 125.

In the embodiment shown in FIG. 12, connection member 200 is provided with support shoulders 202. Shoulders 200 are angled at a degrees which conforms to the SAE standards for lug nut recess 204 on the wheel 206. Thus when connection member 200 is inserted over lug nut 208 pressed up against wheel 206 the support shoulders 202 fit within recess 204 and engage shoulders 210. Lug nut 212 is then tightened to retain the mount in place.

However, many cars or trucks today have aluminum or chrome plated wheels and to prevent damage to the wheel a spacer 214 may be used. Spacer 214 is preferably made from aluminum or another softer metal or plastic and acts to prevent support shoulders 202 from damaging the wheel. Wheel spacer 214 is inserted over lug nut 208 on wheel 206. Rear shoulders 217 of spacer 214 engage support shoulders 202.

Finally, it will be understood by those skilled in the art that all illustrated embodiments are to be constructed in accordance with applicable ASTM (American Society for Testing and Materials) standards for lifting devices as well as all applicable SAE (Society of Automotive Engineers) standards. This includes the nature and quality of the welds along with materials used in manufacturing the various illustrative embodiments of the jacking mount in FIGS. 1 through 12.

While a particular form of the invention has been illustrated and described, it will also be apparent to those skilled in the art that various modifications can be made without departing from the spirit and the scope of the present invention. One such modification relates to the compatibility of the invention with wheels that contain recessed lug nuts or bolts. In this regard, the connection members of the present invention can be configured so as to fit into recesses in the wheels coinciding with the openings for lug nuts or bolts. The practice of recessing lug nuts or bolts is popular with automobiles wheel manufacturers.

Additional connection members can also be added in order to strengthen the connection between the wheel hub and the mount or for the purpose of functioning with wheels with more lug nuts or bolts. The shape of the cross-section of the jack mount can be other than square or cylindrical. The support bars may also be formed integral to the mounts in order to add rigidity. Moreover, ribs can be added to the mount separately or integrally in order to increase strength and reduce cost of the mount.

The coupling methods can also be by means other than welding such as through epoxy bonding. The mount and associated pieces may be formed from other suitable materials such as heavy duty plastics and composites. The movable connection members displayed in FIGS. 9, 10, and 11 can be included in the rectangular cross-section variant of the invention or in other variants. The above mentioned variations on configurations and materials could save weight, cost, or both. Accordingly, it is not intended that the invention be limited except by the appended claims.

What is claimed is:

1. A vehicular jacking mount for use in connection with a vehicular jack
having a horizontal lifting component comprising:
an elongate, cylindrical body comprising;
a distal and proximal end;
a hollow cross-section for accepting the horizontal component of a conventional vehicular jack in the proximal end;
an inner surface for engaging with the horizontal component of jack;
an outer surface;
a plurality of connection members with openings therein coupled in a substantially perpendicular and radially outward manner to the distal end of the body; and
an elongate reinforcing bar coupled with the cylindrical body between the distal end and the proximal end and along the outer surface of the cylindrical body.

2. The vehicular jack of claim 1 wherein:
a plurality of elongate reinforcing bars are coupled with the cylindrical body between the distal end and the proximal end and along the outer surface of the cylindrical body.

3. The vehicular jack of claim 1 wherein:
the plurality of connection members is configured so that the openings within the connection members are alignable with bolts or studs of a 4, 5, 6, 7, or 8-lug vehicle wheel hub.

4. The vehicular jack of claim 1 wherein:
the plurality of connection members is configured so that the openings within the connection members are slotted so as to accommodate wheels with varying bolt or lug spacing.

5. The vehicular jack of claim 1 wherein:
the plurality of connection members includes only two connection members wherein:
the connection members are separated by an angle of 180 degrees on the distal end of the cylindrical body so that the openings in the connection members are alignable with the upper most and bottom most lug nuts or bolts of a vehicle's wheel hub when the cylindrical body is connected to the wheel.

6. The vehicular jack of claim 1 wherein:
the elongate reinforcing bar is coupled to the cylindrical body with a weld connection.

7. The vehicular jack of claim 1 wherein:
the cylindrical body is comprised of steel; and
the elongate reinforcing bar is comprised of steel.

8. The vehicular jack of claim 1 wherein:
the cylindrical body is comprised of an aluminum alloy; and
the elongate reinforcing bar is comprised of an aluminum alloy.

9. A vehicular jacking mount for use in connection with a vehicular jack
having a horizontal lifting component comprising:
an elongate, square cross-section body comprising;
a distal and proximal end;
a hollow cross-section for accepting the horizontal component of a conventional vehicular jack in the proximal end;
an inner surface for engaging with the horizontal component of jack;
an outer surface;
a plurality of connection members with openings therein coupled in a substantially perpendicular and radially outward manner to the distal end of the body; and
an elongate reinforcing bar coupled with the body between the distal end and the proximal end and along the outer surface of the body.

10. The vehicular jack of claim 9 wherein:
a plurality of elongate reinforcing bars are coupled with the square body between the distal end and the proximal end and along the outer surface of the square body.

11. The vehicular jack of claim 9 wherein:
the plurality of connection members is configured so that the openings within the connection members are alignable with bolts or studs of a 4, 5, 6, 7, or 8-lug vehicle wheel hub.

12. The vehicular jack of claim 9 wherein:
the plurality of connection members is configured so that the openings within the connection members are slotted so as to accommodate wheels with varying bolt or lug spacing.

13. The vehicular jack of claim 9 wherein:
the plurality of connection members includes only two connection members wherein:
the connection members are separated by an angle of 180 degrees on the distal end of the square body so that the openings in the connection members are alignable with the upper most and bottom most lug nuts or bolts of a vehicle's wheel hub when the square body is connected to the wheel.

14. The vehicular jack of claim 9 wherein:
the elongate reinforcing bar is coupled to the square body with a weld connection.

15. The vehicular jack of claim 9 wherein:
the square body is comprised of steel; and
the elongate reinforcing bar is comprised of steel.

16. The vehicular jack of claim 9 wherein:
the square body is comprised of an aluminum alloy; and
the elongate reinforcing bar is comprised of an aluminum alloy.

17. A vehicular jacking mount for use in connection with a vehicular jack
having a horizontal lifting member comprising:
an elongate, cylindrical body comprising;
a distal and proximal end;
a hollow cross-section for accepting the horizontal component of a conventional vehicular jack in the proximal end;
an inner surface for engaging with the horizontal component of jack;
an outer surface;
a collar coupled to the outer surface of the cylinder at the distal end;
a plurality of connection members with openings therein positioned radially between the collar and the cylinder in a freely circumferentially rotating and substantially perpendicular and radially outward manner;
an elongate reinforcing bar coupled with the cylindrical body between the distal end and the proximal end and along the inner surface of the cylindrical body.

18. The vehicular jack of claim 17 wherein:
a plurality of elongate reinforcing bars are coupled with the cylindrical body between the distal end and the proximal end and along the outer surface of the cylindrical body.

19. The vehicular jack of claim 17 wherein:
the plurality of connection members is configured so that the openings within the connection members are alignable with bolts or studs of a 4, 5, 6, 7, or 8-lug vehicle wheel hub.

20. The vehicular jack of claim 17 wherein:
the plurality of connection members is configured so that the openings within the connection members are slotted so as to accommodate wheels with varying bolt or lug spacing.

21. The vehicular jack of claim 17 wherein:
the plurality of connection members includes only two connection members wherein:
the connection members are separated by an angle of 180 degrees on the distal end of the cylindrical body so that the openings in the connection members are alignable with the upper most and bottom most lug nuts or bolts of a vehicle's wheel hub when the cylindrical body is connected to the wheel.

22. The vehicular jack of claim 17 wherein:
the elongate reinforcing bar is coupled to the cylindrical body with a weld connection.

23. The vehicular jack of claim 17 wherein:
the collar is coupled to the cylindrical body with weld connections.

24. The vehicular jack of claim 17 wherein:
the cylindrical body is comprised of steel;
the collar is comprised of steel; and
the elongate reinforcing bar is comprised of steel.

25. The vehicular jack of claim 17 wherein:
the cylindrical body is comprised of an aluminum alloy;
the collar is comprised of aluminum alloy; and
the elongate reinforcing bar is comprised of an aluminum alloy.

26. A method for lifting a vehicle wherein:
an elongate body is attached to a wheel of a vehicle;
a jack with a substantially horizontal lifting component is placed in close proximity with the body;
the lifting component of the jack is inserted into the hollow cross-section of the body; and
the jack is manipulated so as to raise the vehicle by the interaction between the lifting component and inner surface of the body.

27. The vehicular jack of claim 1 where each of said plurality of connection members includes support shoulder extending circumferential above said openings.

28. The vehicular jack of claim 27 further including a spacer member for engaging said support shoulder.

29. The vehicular jack of claim 9 where each of said plurality of connection members includes support shoulder extending circumferential above said openings.

30. The vehicular jack of claim 29 further including a spacer member for engaging said support shoulder.

31. The vehicular jack of claim 17 where each of said plurality of connection members includes support shoulder extending circumferential above said openings.

32. The vehicular jack of claim 28 further including a spacer member for engaging said support shoulder.
